(19) United States
(12) Patent Application Publication
(10) Pub. No.: US 2022/0351137 A1
(43) Pub. Date: Nov. 3, 2022

(54) Systems And Methods To Provide Advice To A Driver Of A Vehicle Involved In A Traffic Accident

(71) Applicant: Ford Global Technologies, LLC, Dearborn, MI (US)

(72) Inventors: Danielle Rosenblatt, Madison Heights, MI (US); Jeremy Lerner, Southfield, MI (US); Scott Huggins, Novi, MI (US); Xingping Chen, Troy, MI (US); Navid Tafaghodi Khajavi, Troy, MI (US)

(73) Assignee: Ford Global Technologies, LLC, Dearborn, MI (US)

(21) Appl. No.: 17/242,540

(22) Filed: Apr. 28, 2021

(51) Int. Cl. G06Q 10/10; G06Q 50/26; G07C 5/00; H04W 4/02; H04W 4/46

(52) U.S. Cl. CPC G06Q 10/10; G06Q 50/26; G07C 5/008; H04W 4/025; H04W 4/46

(57) ABSTRACT

This disclosure is generally directed to systems and methods related to providing advice to a driver of a vehicle involved in a traffic accident. In an example embodiment, a sensor generates a sensor signal based on detecting a traffic accident involving the vehicle in which the sensor is mounted. A computer evaluates the sensor signal and identifies various actions to be performed in conformance with legal and/or insurance requirements applicable to the site of the traffic accident. The legal and/or insurance requirements can vary from one site to another (state to state, for example). The computer may carry out some of the actions automatically and may provide an advisory to the driver of the vehicle to carry out some other actions, such as to exit or stay in the vehicle and to move or not to move the vehicle.

### BACKGROUND

After a traffic accident, a first driver may react by maintaining a calm demeanor and may perform various actions in a relatively logical manner. However, a second driver involved in the traffic accident may be shaken up to a degree that renders the second driver incapable of performing follow-up actions such as, for example, capturing pictures, exchanging insurance information, and contacting the police.

In some cases, a driver involved in a traffic accident may be unaware, or may be uncertain, about what steps to take next. For example, the driver may not know whether to move the car to a safer spot or to leave it undisturbed for the authorities, whether to wait inside the vehicle or to step out, if safe, and/or whether to file a police report immediately or at a later time. Furthermore, some of the steps to be taken may vary from one place to another based on jurisdiction.

It is therefore desirable to provide a solution that addresses issues such as the ones described above.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example vehicle that includes a driver advisory system in accordance with an embodiment of the disclosure.

FIG. 2 illustrates an example scenario where the driver advisory system performs certain operations in accordance with the disclosure.

FIG. 3 illustrates an example advisory that is displayed in accordance with the disclosure after a vehicle is involved in a traffic accident.

FIG. 4 illustrates another example advisory that is displayed in accordance with the disclosure after a vehicle is involved in a traffic accident.

FIG. 5 shows some example components that may be provided in a vehicle in accordance with an embodiment of the disclosure.

### DETAILED DESCRIPTION

### Overview

In terms of a general overview, certain embodiments described in this disclosure are directed to systems and methods related to providing advice to a driver of a vehicle involved in a traffic accident. In an example embodiment, a sensor generates a sensor signal based on detecting a traffic accident involving the vehicle in which the sensor is mounted. A computer evaluates the sensor signal and identifies various actions to be performed in conformance with legal requirements, insurance requirements applicable to the site of the traffic accident, and/or personal preferences of the driver of the vehicle. The legal and/or insurance requirements can vary from one site to another (state to state, for example). The personal preferences of the driver may include, for example, a reminder to carry out certain actions such as to file an insurance claim and/or a police report even if not required by the insurance agency and/or the police to do so. The computer may automatically carry out some actions and may provide an advisory to the driver based on other actions that are to be performed by the driver (getting out of the vehicle, if safe, moving the vehicle to a safe spot, etc.).

It must be understood that various actions described herein with reference to a driver of a vehicle can be autonomously performed by the vehicle when the vehicle is an autonomous vehicle. For example, an autonomous vehicle may autonomously move the vehicle to a safe spot on a shoulder of a road after the occurrence of a traffic accident.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words, terms, and phrases that are used in this disclosure must be interpreted as referring to various objects and actions that are generally understood in various forms and equivalencies by persons of ordinary skill in the art. For example, the word “software” as used herein encompasses any of various forms of computer code and may be provided in various forms such as in the form of a software package, a firmware package, retail software, or Original Equipment Manufacturer (OEM) software. The word “sensor” as used herein includes any of various forms of sensing devices, detection devices, and image capture devices. The word “cooperate,” as used herein with reference to two or more devices, refers to transfer of information between the devices. The word “information,” as used herein with reference to devices, refers to any of various forms of data produced by the device. The phrase “circumstantial factor” as used herein refers to circumstances and factors associated with a traffic accident, particularly circumstances and factors associated a site of a traffic accident. The word “example” as used herein is intended to be non-exclusionary and non-limiting in nature.

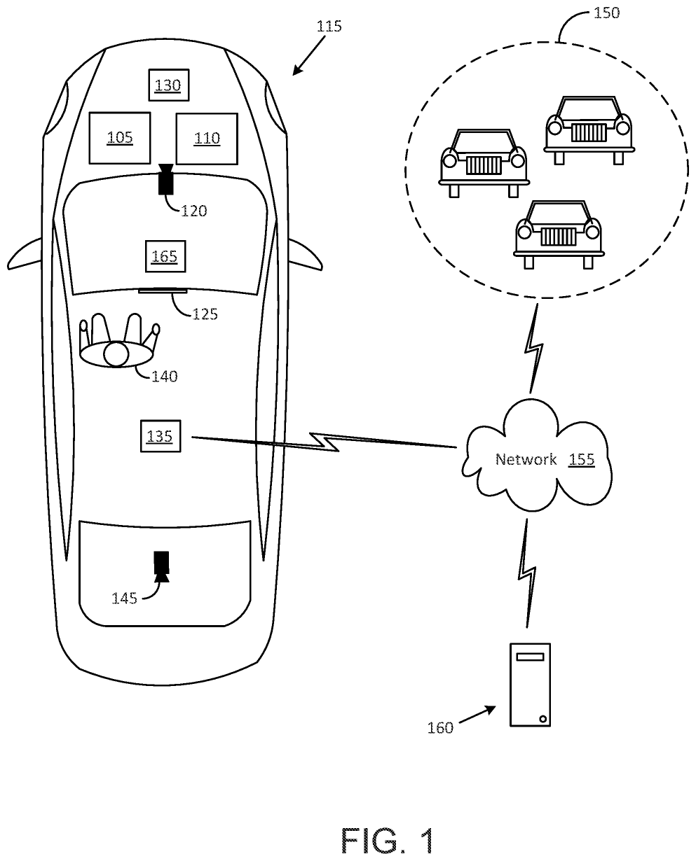

FIG. 1 illustrates an example vehicle 115 that is configured to execute various operations in accordance with the disclosure. The vehicle 115 may be any of various types of vehicles such as, for example, a gasoline powered vehicle, an electric vehicle, a hybrid electric vehicle, or an autonomous vehicle, a car, a sports utility vehicle (SUV), a truck, a van, a semi-trailer truck, a bus, or an autonomous vehicle. The vehicle 115 may include components such as a vehicle computer 110, a driver advisory system 105, an infotainment system 125, a sensor system 130, a global positioning satellite (GPS) device 165, and a communication system 135.

The vehicle computer 110 may perform various functions such as controlling engine operations (fuel injection, speed control, emissions control, braking, etc.), managing climate controls (air conditioning, heating etc.), activating airbags, and issuing warnings (check engine light, bulb failure, low tire pressure, vehicle in blind spot, etc.). In some cases, the vehicle computer 110 may include more than one computer such as, for example, a first computer that controls engine operations and a second computer that operates the infotainment system 125.

The driver advisory system 105 can include a computer having a processor and a memory in which is stored computer-executable instructions that are executed by the processor to enable the computer to perform various operations in accordance with the disclosure. In an example implementation, the driver advisory system 105 can include a standalone computer that is communicatively coupled to the vehicle computer 110 and other devices in the vehicle 115. In another example implementation, the driver advisory system 105 can be a part of the vehicle computer 110 and share some components with the vehicle computer 110, such as, for example a processor and a memory.

The driver advisory system 105 may be coupled to the sensor system 130, which can include various types of devices such as, for example, an accelerometer, a video camera, a digital camera, an infrared camera, an object detector, a distance sensor, a proximity sensor, an audio sensor, a light detection and ranging (LIDAR) device, a radar device, and/or a sonar device. In an example embodiment, the driver advisory system 105 is coupled to a camera 120, a camera 145, an accelerometer of the sensor system 130, and other sensors and detectors.

The camera 120 can be any of various types of image capture devices mounted at any of various locations on the vehicle 115 such as, for example, on a dashboard, a front bumper, or in the engine compartment. The camera 120 is arranged to capture images of objects ahead of the vehicle 115. The images may be still pictures, video clips, or video streams, for example. The camera 145, which can be similar to camera 120, may be mounted on a rear window, rear bumper, or trunk of the vehicle 115 and arranged to capture images of objects behind the vehicle 115.

In an example scenario, the accelerometer, which may also be referred to as a “g sensor,” produces a sensor signal upon detecting an abrupt change in motion of the vehicle 115, such as, for example, a sudden deceleration or stoppage of the vehicle 115. The sensor signal is propagated to the driver advisory system 105 and the vehicle computer 110, each of which evaluates the sensor signal and determines that the vehicle 115 is involved in a traffic accident. In one case, the traffic accident can be a collision between the vehicle 115 and another vehicle. The collision can be, for example, a rear-ending of the vehicle 115 by another vehicle, or vice-versa.

In an example situation, where the vehicle 115 rear-ends the other vehicle, the camera 120, which can be a video camera executing a real-time video recording, captures and stores video footage prior to, and after, the moment of impact between the two vehicles. The video footage may be stored in a memory device for access by the driver advisory system 105 in accordance with disclosure.

In another example situation, where the vehicle 115 is rear-ended by the other vehicle, the camera 145, which can be a video camera executing a real-time video recording, captures and stores video footage prior to, and after, the moment of impact between the two vehicles. The video footage may be stored in a memory device for access by the driver advisory system 105 in accordance with disclosure.

The infotainment system 125 can be an integrated unit that includes various components such as a radio, a CD player, and a video player. In an example implementation, the infotainment system 125 has a display that includes a graphical user interface (GUI) for use by a driver 140 of the vehicle 115. The GUI may be used for various purposes including, for example, to input destination information for obtaining navigation assistance. The navigation assistance may be obtained via signals provided by the GPS device 165 that is coupled to the infotainment system 125 (and the driver advisory system 105).

The communication system 135 can include wired and/or wireless communication devices mounted in or on the vehicle 115 in a manner that support various types of communications such as, for example, communications between the driver advisory system 105 and the vehicle computer 110. The communication system 135 may utilize one or more of various wired and/or wireless technologies for this purpose, such as, for example, Bluetooth®, Ultra-Wideband (UWB), Wi-Fi, Zigbee®, Li-Fi (light-based communication), audible communication, ultrasonic communication, and/or near-field-communications (NFC).

The driver advisory system 105 and the vehicle computer 110 can also utilize the communication system 135 to communicate with devices that are located outside the vehicle 115, such as, for example, computers located in other vehicles (the vehicles are illustrated inside a dashed circle 150) and a computer 160. Such communications may be carried out via a network 155. The network 155 may include any one network, or a combination of networks, such as, for example, a local area network (LAN), a wide area network (WAN), a telephone network, a cellular network, a cable network, a wireless network, and/or private/public networks such as the Internet. The network 155 may support one or more types of communication technologies such as, for example, Transmission Control Protocol/Internet Protocol (TCP/IP), Cellular, Bluetooth®, Ultra-Wideband, near-field communication (NFC), Wi-Fi, Wi-Fi direct, Li-Fi, vehicle-to-vehicle (V2V) communications, vehicle-to-infrastructure (V2I) communications, and vehicle-to-everything (V2X) communications.

In various implementations, the computer 160 can be a server computer, a cloud computer, or a client computer. The computer 160 can be an independent computer or can be a part of a system of computers associated with various entities such as, for example, a public records office, a vehicle records office, a medical facility, a police station, and an insurance agency. In some cases, the computer 160 may be operated by an individual such as, for example, a police official, an insurance agent, or a medical professional. In some scenarios, the individual may operate the computer 160 to communicate with the driver 140 of the vehicle 115 (via the network 155, the communication system 135, and the driver advisory system 105) to provide various types of information and/or advice in the event of a traffic accident.

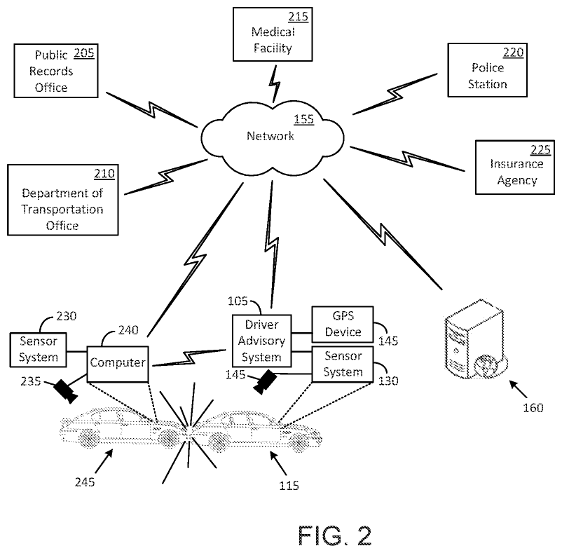

FIG. 2 illustrates an example scenario where the vehicle 115 is involved in a collision, and the driver advisory system 105 performs certain operations in accordance with the disclosure. In this example scenario, the vehicle 115 has been rear-ended by another vehicle 245.

The other vehicle 245 may include a computer 240 that is configured to communicate with computers in other vehicles such as, for example, a computer of the driver advisory system 105 in the vehicle 115. The communications may be carried out either via the network 155 or directly between the two vehicles (without propagation through the network 155). Communications executed via the network 155 may be carried out by using any of various communication technologies such as, for example, TCP/IP or Cellular, and communications carried out directly between the two vehicles can, for example, use vehicle-to-vehicle (V2V) communications. In some cases, a sensor system 230 and/or a camera 235 may be coupled to the computer 240.

An accelerometer of the sensor system 130 in the vehicle 115 detects the collision and generates a sensor signal that is propagated to the driver advisory system 105. The driver advisory system 105 evaluates the sensor signal and determines that the vehicle 115 has been involved in a traffic accident (a collision, in this case). The driver advisory system 105 then communicates with the GPS device 165 to obtain location information of the vehicle 115. The location information of the vehicle 115 is used by the driver advisory system 105 to identify a site of the accident such as, for example, on Highway 131 in the state of Michigan. In some cases, additional location information such as, for example, a county, a district, a town, or a city may be identified as well. In some cases, the collision may be detected by other types of sensors and/or reported to the driver advisory system 105 by the driver 140 of the vehicle 115 (via the GUI of the infotainment system 125, for example).

After identifying the site of the traffic accident, the driver advisory system 105 communicates with one or more agencies to obtain information on actions to be performed by the driver 140 of the vehicle 115 in conformance with various circumstantial factors associated with the site. In some cases, the information may be available in a database that is a part of the driver advisory system 105, thereby eliminating the need to contact various agencies via the network 155. Some example circumstantial factors can include legal requirements (a state law, a federal law, a county law, etc.) and insurance requirements. Information about the legal requirements may be obtained by the driver advisory system 105 from the public records office 205, the police station 220, and/or the department of transportation (DOT) office 210. The legal requirements in this example scenario, can be local (county in Michigan), state-wide (state highway in Michigan), and/or federal (interstate highway passing through Michigan). In other scenarios the legal requirements may be different such as, for example, if the traffic accident were to occur in a different state, county, or city.

Information about the insurance requirements may be obtained for example, from the insurance agency 225 and the DOT office 210. The insurance requirements in this example scenario, which can be local, state-wide, and/or federal, may be related, for example, to vehicle registration, vehicle inspection, and taxes.

The driver advisory system 105 may evaluate the legal requirements and/or insurance requirements to determine one or more actions that are expected of the driver 140, based on the site of the traffic accident. The actions can include, for example, exchanging insurance information with the driver of the other vehicle, moving the vehicle 115 to a safe spot, refraining from moving the vehicle 115, placing a phone call to the police, and/or obtaining a police report. It may be against the law at one site to move the vehicle 115 from the site of the traffic accident (so as to enable the police to evaluate the accident). It may also be necessary to obtain a police report for filing an insurance claim.

At another site it may be required to move the vehicle 115 off the road and on to a safe spot on a shoulder so as to minimize impact on traffic moving on the road and/or to avoid causing a secondary accident. It may also be unnecessary at this other site to obtain a police report at the time of the traffic accident for purposes of filing an insurance claim.

The driver advisory system 105 may further determine one or more actions that can be performed automatically by the driver advisory system 105 without involvement of the driver 140, and other actions that are to be performed by the driver 140. Actions that are to be performed by the driver 140 may be based on assessing a physical and/or mental condition of the driver 140 due to the traffic accident. The assessment may be carried out by the driver advisory system 105 in cooperation with sensing devices such as, for example, a heart rate monitor and/or a blood pressure monitor, and/or by evaluating images captured by a camera located in a cabin area of the vehicle 115.

In one example situation, the driver 140 may be relatively composed and may be capable of performing some operations such as, for example, placing a phone call, operating the vehicle 115, or getting out of the vehicle 115. In another example situation, the driver 140 may be shaken up to a point where the driver 140 is incapable of performing such operations. In such cases, the driver advisory system 105 may automatically contact the medical facility 215, the police station 220, and/or emergency contacts that may be specified by the driver 140.

A first example action that can be automatically performed by the driver advisory system 105 can involve obtaining information from the computer 240 of the vehicle 245 and/or from the DOT office 210. The information may be obtained via V2V communications and can include, for example, a vehicle identification number (VIN), vehicle registration information, and/or vehicle ownership information.

A second example action that can be automatically performed by the driver advisory system 105 can involve obtaining information about the traffic accident. The information may be obtained, for example, in the form of images captured by the camera 145. The images may provide information related to aspects such as damage, angle of impact, severity of impact, location on road (inside a lane or outside the lane, for example), traffic signs (a stop sign, for example), and/or an identity of the driver of the vehicle 245 (facial photo, for example).

A third example action that can be automatically performed by the driver advisory system 105 can involve transferring information to the police station 220 and/or the insurance agency 225 (such as, for example, traffic accident information, insurance information, and claims). The information may include, for example, images captured by the camera 145 in the manner described above. In some cases, the information may also be transferred to a personal communications device carried by the driver 140 (smartphone, wearable computer, etc.). The information may be used by the driver 140 for personal purposes such as for, example, record keeping and personal reference.

A fourth example action that can be automatically performed by the driver advisory system 105 can involve advising the driver 140 on what actions to take. The driver advisory system 105 may provide various types of advice based on legal requirements applicable at the site of the traffic accident, insurance requirements applicable at the site of the traffic accident, and traffic conditions present at the site of the accident (traffic speed, number of lanes on road, nature of the lane in which the accident occurred, availability of a shoulder, etc.)

In a first example scenario, the driver advisory system 105 may cooperate with the vehicle computer 110 to evaluate a drivability condition of the vehicle 115. If found drivable, the driver advisory system 105 may advice the driver 140 to move the vehicle 115 away from traffic and to a safe location such as, for example, a shoulder on the road or a location off an exit ramp. The legal requirement applicable to the site of the accident may necessitate this action so as to prevent hindrance to traffic moving on the road. When the vehicle 115 is an autonomous vehicle, the driver advisory system 105 may cooperate with the vehicle computer 110 to autonomously move the vehicle 115 away from the site of the traffic accident and to a safe location.

In a second example scenario, the driver advisory system 105 may advise the driver 140 to refrain from moving the vehicle 115 away from the spot of the accident (even if the spot of the accident is in the middle of a road and is disrupting traffic flow). The legal requirement in this case may necessitate this action so as to allow a police official to evaluate the accident and draw up a police report. Obtaining a police report may be another legal requirement that is applicable to this site of the traffic accident. When the vehicle 115 is an autonomous vehicle, the driver advisory system 105 may cooperate with the vehicle computer 110 to place the vehicle 115 in a parked condition at the spot of the accident.

In a third example scenario, the driver advisory system 105 may advise the driver 140 to stay inside the vehicle 115 as it may be unsafe for the driver 140 to step out into traffic moving around the vehicle 115. The legal requirement applicable to the site of the accident may be directed at protecting the driver 140 from harm caused by other vehicles moving on the road.

In a fourth example scenario, the driver advisory system 105 may advise the driver 140 to get out of the vehicle 115 and move to a safe location such as, for example, a shoulder on the road or a location off an exit ramp. The legal requirement applicable to the site of the accident may be directed at protecting the driver 140 from harm that may be caused by vehicles moving on the road. In an example implementation, the advice provided by the driver advisory system 105 may be based on a medical evaluation performed by the driver advisory system 105 upon the driver 140 (and possibly, on other occupants of the vehicle 115). The driver advisory system 105 may also advice the driver 140 to capture images associated with the traffic accident after moving to the safe location. The images may be used later on by a police official or an insurance agent.

In an example situation, the driver advisory system 105 may determine that the driver 140 has suffered a debilitating injury that would make it hazardous for the driver 140 to move (such as, for example, a neck injury, a head injury, or a back injury). The driver advisory system 105 may consequently advice the driver 140 to remain motionless in the vehicle 115 so as to prevent further damage.

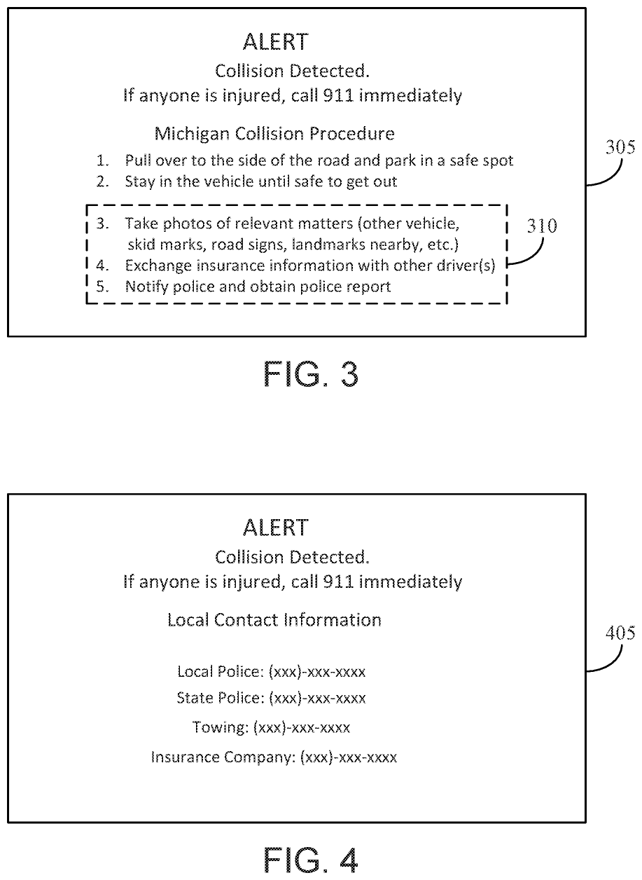

FIG. 3 illustrates an example advisory 305 that may be displayed after the vehicle 115 is involved in a traffic accident, in accordance with the disclosure. The example advisory 305, which includes a set of instructions to the driver 140, may be displayed on any of various devices such as, for example, on a display screen of the infotainment system 125 and/or on a personal communications device carried by the driver 140 (smartphone, wearable computer, etc.). The instructions shown inside the dashed line box 310 may be omitted if the driver advisory system 105 determines that the instructions are not needed in view of legal requirements and/or insurance requirements at the site of the traffic accident. In some implementations, such instructions (and more) may be displayed pre-emptively before the occurrence of a traffic accident, so as to educate the driver 140 on what actions are to be taken in case of an accident. The instructions may be made available at any time, for example, upon request by the driver 140 via the GUI of the infotainment system 125.

FIG. 4 illustrates another example advisory 405 that may be displayed in accordance with the disclosure after the vehicle 115 is involved in a traffic accident. The information provided in the advisory 405 may be obtained by the driver advisory system 105 via communications with various sources such as, for example, the police station 220, emergency services (911 center), and a towing company each of which may be located closest to the site of the traffic accident. In some implementations, such information may be stored in the cloud and maintained by various entities such as, for example, an OEM vendor.

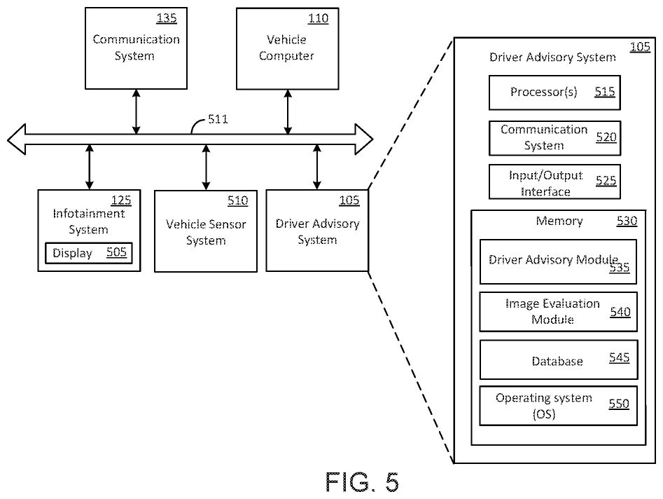

FIG. 5 shows some example components that may be included in the vehicle 115 in accordance with an embodiment of the disclosure. The example components may include the communication system 135, the vehicle computer 110, the infotainment system 125, a vehicle sensor system 510, and the driver advisory system 105. The various components are communicatively coupled to each other via one or more buses such as an example bus 511. The bus 511 may be implemented using various wired and/or wireless technologies. For example, the bus 511 can be a vehicle bus that uses a controller area network (CAN) bus protocol, a Media Oriented Systems Transport (MOST) bus protocol, and/or a CAN flexible data (CAN-FD) bus protocol. Some or all portions of the bus 511 may also be implemented using wireless technologies such as Bluetooth®, Bluetooth®, Ultra-Wideband, Wi-Fi, Zigbee®, or near-field-communications (NFC). For example, the bus 511 may include a Bluetooth® communication link that allows the driver advisory system 105 and the vehicle sensor system 510 to wirelessly communicate with each other and/or with the vehicle computer 110.

The communication system 135 can include wired and/or wireless communication devices mounted in or on the vehicle 115 in a manner that support various types of communications such as, for example, communications between the driver advisory system 105 and the vehicle computer 110. The communication system 135 may also allow the driver advisory system 105 to communicate with devices located outside the vehicle 115, such as, for example, computers located in places such as the police station 220, the insurance agency 225, and the DOT office 210.

In an example implementation, the communication system 135 can include a single wireless communication unit that is coupled to a set of wireless communication nodes. In some cases, the wireless communication nodes can include a Bluetooth® low energy module (BLEM) and/or a Bluetooth® low energy antenna module (BLEAM).

The infotainment system 125 can include a display 505 having a GUI for carrying out various operations. The GUI may be used to allow the driver 140 to input information such as, for example, a response to a query from the driver advisory system 105 regarding a medical condition of the driver 140 after a traffic accident. The display 505 may also be used to display advisories such as the advisory 305 and the advisory 405 described above.

The vehicle sensor system 510 can include various types of sensors such as, for example, the camera 120, the camera 145, an accelerometer, an object detector, a distance sensor, a proximity sensor, an audio sensor, a LIDAR device, a radar device, and/or a sonar device.

The driver advisory system 105 may include a processor 515, a communication system 520, an input/output interface 525, and a memory 530. The communication system 520 can include one or more wireless transceivers (BLEMs, for example) that allow the driver advisory system 105 to communicate with the vehicle computer 110 (via the bus 511) and other computers (wirelessly via the network 155).

The input/output interface 525 can be used to allow various types of signals and information to pass into, or out of, the driver advisory system 105. For example, the input/output interface 525 may be used by the driver advisory system 105 to receive a sensor signal from an accelerometer upon the occurrence of a traffic accident and may be used to exchange communications with various other sensors present in the vehicle 115. The driver advisory system 105 can evaluate the sensor signal received from the accelerometer and identify the occurrence of the traffic accident. The driver advisory system 105 may then transmit a command to one or more cameras to capture images such as, for example, images of the other vehicle involved in the accident, images of damaged potions of the vehicle 115, images of damaged potions of the other vehicle, images of traffic signals, and/or images of landmarks.

The input/output interface 525 may also be used to receive and/or transmit signals to the vehicle computer 110. For example, the input/output interface 525 may be used to receive status information about an operability of the vehicle 115 from the vehicle computer 110 after a traffic accident. When the vehicle 115, is an autonomous vehicle, the driver advisory system 105 may in one situation, communicate via the input/output interface 525 with the vehicle computer 110 to move the vehicle 115 away from a spot of an accident and to a safe location.

The memory 530, which is one example of a non-transitory computer-readable medium, may be used to store an operating system (OS) 550, a database 545, and various code modules such as a driver advisory module 535 and an image evaluation module 540. The code modules are provided in the form of computer-executable instructions that are executed by the processor 515 to enable the driver advisory system 105 to perform various operations in accordance with the disclosure. The driver advisory module 535 can be executed for example, by the processor 515, to perform various operations such as evaluating a sensor signal received from the vehicle sensor system 510 (and/or the vehicle computer 110) and for evaluating various circumstantial factors associated with a traffic accident.

Execution of some of these operations can include the use of the image evaluation module 540 in order to evaluate various types of images such as, for example, images captured by the camera 120 and/or the camera 145. The database 545 may be used to store various types of data such as images, legal requirements, and insurance requirements.

It must be understood that in various embodiments, actions performed by the processor 515 of the driver advisory system 105 can be performed by other processors in other computers, such as, for example, a processor in the vehicle computer 110 and/or a processor in the computer 160. In an example scenario, the computer 160 may perform the action of evaluating the traffic accident in view of legal requirements applicable at the site of the traffic accident, and another computer located at the insurance agency 225 may perform the action of evaluating the traffic accident in view of insurance requirements applicable at the site of the traffic accident. The actions performed by such other computers may be carried out in cooperation with, or in lieu, of the processor 515 of the driver advisory system 105.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, such as the processor 515, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device such as the memory 530, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
generating, by a sensor system in a first vehicle, a sensor signal associated with a traffic accident;
determining, based on evaluating the sensor signal, an action to be performed by a driver of the first vehicle in conformance with a legal requirement and/or an insurance requirement applicable at a site of the traffic accident; and
providing, to the driver of the first vehicle, an advisory based on the action to be performed.

2. The method of claim 1, further comprising:
receiving, from a global positioning system (GPS) device, GPS location coordinates of the first vehicle;
identifying, based on the GPS location coordinates, the site at which the traffic accident occurred; and
identifying the legal requirement applicable to the traffic accident at the site and/or the insurance requirement applicable to the traffic accident at the site.

3. The method of claim 2, wherein the legal requirement comprises a state law, a federal law, and/or a regional law, and wherein the insurance requirement comprises exchanging of insurance information between drivers involved in the traffic accident and/or obtaining a police report.

4. The method of claim 3, further comprising:
automatically exchanging insurance information between the first vehicle and a second vehicle involved in the traffic accident.

5. The method of claim 3, further comprising:
transferring, to a police agency and/or an insurance agency, insurance information, vehicle information, and/or driver information associated with the first vehicle and/or a second vehicle involved in the traffic accident.

6. The method of claim 3, wherein the sensor system comprises a camera and the method further comprises:
capturing, by the camera, an image associated with the traffic accident; and
automatically transferring, to a police agency and/or an insurance agency, the image associated with the traffic accident.

7. A method comprising:
detecting, by a sensor system in a first vehicle, an occurrence of a traffic accident at a first site;
identifying a circumstantial factor associated with the traffic accident; and
providing, to a driver of the first vehicle, an advisory based on the circumstantial factor.

8. The method of claim 7, wherein the circumstantial factor comprises a legal requirement in force at the first site and/or an insurance requirement applicable to the traffic accident at the first site.

9. The method of claim 8, comprising:
receiving, from a global positioning system (GPS) device, GPS location coordinates of the first vehicle;
identifying the first site based on the GPS location coordinates;
transmitting, to a server computer, a request for information about the legal requirement in force at the first site and/or the insurance requirement applicable to the traffic accident at the first site.

10. The method of claim 9, further comprising:
providing, to the driver of the first vehicle, the advisory based on the information about the legal requirement in force at the first site and/or the insurance requirement applicable to the traffic accident at the first site.

11. The method of claim 10, wherein the legal requirement comprises a state law, a federal law, and/or a regional law, and wherein the insurance requirement comprises exchanging of insurance information between parties involved in the traffic accident and/or obtaining a police report.

12. The method of claim 11, further comprising:
automatically exchanging insurance information, vehicle information, and/or driver information between the first vehicle and a second vehicle involved in the traffic accident.

13. The method of claim 7, wherein the sensor system comprises a camera, and wherein the method further comprises:
capturing, by the camera, an image associated with the traffic accident; and
automatically transferring, to a police agency and/or an insurance agency, the image captured by the camera.

14. The method of claim 7, wherein the circumstantial factor associated with the traffic accident includes a traffic speed characteristic at the first site, and wherein the advisory provided to the driver of the first vehicle comprises:
advising the driver of the first vehicle to exit the first vehicle if safe to do so, remain in the first vehicle, move the first vehicle to a safe spot, and/or refrain from moving the first vehicle.

15. A vehicle comprising:
a sensor system; and
a first computer comprising:
a memory that stores computer-executable instructions; and
a processor configured to access the memory and execute the computer-executable instructions to perform operations comprising:
receiving, from the sensor system, a sensor signal;
identifying, based on the sensor signal, a traffic accident at a first site;
providing, to a driver of the vehicle, an advisory that is based on a circumstantial factor associated with the traffic accident.

16. The vehicle of claim 15, further comprising a global positioning system (GPS) device, and wherein the processor is further configured to access the memory and execute additional computer-executable instructions to perform operations comprising:
receiving, from the GPS device, GPS location coordinates of the first vehicle;
determining, based on the GPS location coordinates, a site at which the traffic accident occurred; and
identifying the circumstantial factor based on determining the site at which the traffic accident occurred, wherein the circumstantial factor comprises a legal requirement in force at the first site and/or an insurance requirement applicable to the traffic accident at the first site.

17. The vehicle of claim 16, wherein the processor is further configured to access the memory and execute computer-executable instructions to perform operations comprising:
transferring, to a police agency and/or an insurance agency, insurance information, vehicle information, and/or driver information.

18. The vehicle of claim 16, wherein the processor is further configured to access the memory and execute computer-executable instructions to perform operations comprising:
automatically exchanging insurance information with a second computer located in a second vehicle involved in the traffic accident.

19. The vehicle of claim 15, wherein the sensor system comprises a camera that captures an image associated with the traffic accident, and wherein the processor is further configured to access the memory and execute computer-executable instructions to perform operations comprising:
automatically transferring, to a police agency and/or an insurance agency, the image captured by the camera.

20. The vehicle of claim 15, wherein the processor is further configured to access the memory and execute computer-executable instructions to perform operations comprising:
advising the driver of the vehicle to one of exit the vehicle if safe to do so, remain in the vehicle, move the vehicle to a safe spot, or refrain from moving the vehicle.
